(19) United States
(12) Patent Application Publication
(10) Pub. No.: US 2022/0183061 A1
(43) Pub. Date: Jun. 9, 2022

(54) TRANSMITTING AND RECEIVING AN INDICATION

(71) Applicant: Telefonaktiebolaget LM Ericsson (publ), Stockholm (SE)

(72) Inventors: Min WANG, Luleå (SE); Jinhua LIU, Beijing (CN)

(73) Assignee: Telefonaktiebolaget LM Ericsson (publ), Stockholm (SE)

(21) Appl. No.: 17/607,465

(22) PCT Filed: Apr. 23, 2020
(86) PCT No.: PCT/EP2020/061306

§ 371 Date: Oct. 29, 2021

(30) Foreign Application Priority Data
Apr. 30, 2019 (CN) PCT/CN2019/085244

(51) Int. Cl. H04W 74/08

(52) U.S. Cl. CPC H04W 74/0808

(57) ABSTRACT

The method comprises receiving an allocation of transmission occasions of a channel on a plurality of time periods, and transmitting an indication that no information will be transmitted on at least one of the plurality of transmission occasions.

### TECHNICAL FIELD

Examples of the present disclosure relate to transmitting and receiving an indication.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### NR in Unlicensed Spectrum (NR-U)

Currently the 5th generation cellular wireless communication system, called New Radio (NR), is being standardized in 3GPP. NR is developed for maximum flexibility to support multiple and substantially different use cases. Besides the typical mobile broadband use case, use cases may also include machine type communication (MTC), ultra-low latency critical communications (ULLCC), Ultra Reliable Low Latency Communications (URLLC), side-link device-to-device (D2D) and several other use cases too.

In NR, the basic scheduling unit is called a slot. A slot consists of 14 OFDM symbols for the normal cyclic prefix configuration. NR supports many different subcarrier spacing configurations (numerologies) and, in an example, at a subcarrier spacing of 30 kHz the OFDM symbol duration is ˜33 us. As an example, a slot with 14 symbols for the same subcarrier spacing (SCS) is 500 us long (including cyclic prefixes).

NR also supports flexible bandwidth configurations for different UEs on the same serving cell. In other words, the bandwidth monitored by a UE and used for its control and data channels may be smaller than the carrier bandwidth. One or multiple bandwidth part configurations for each component carrier can be semi-statically signaled to a UE, where a bandwidth part consists of a group of contiguous physical resource blocks (PRBs). Reserved resources can be configured within the bandwidth part. The bandwidth of a bandwidth part equals or is smaller than the maximal bandwidth capability supported by a UE.

NR is targeting both licensed and unlicensed bands, including a work item named NR-based Access to Unlicensed Spectrum (NR-U). Allowing unlicensed networks, i.e., networks that operate in shared spectrum (or unlicensed spectrum), to effectively use the available spectrum is an attractive approach to increase system capacity. Although unlicensed spectrum may not match the qualities of licensed spectrum in some cases, solutions that allow an efficient use of unlicensed spectrum as a complement to licensed deployments have the potential to bring value to 3GPP operators and ultimately, to the 3GPP industry as a whole. It is expected that some features in NR will need to be adapted to comply with the special characteristics of the unlicensed band as well as different regulations. For example, a subcarrier spacing of 15 or 30 kHz are promising candidates for NR-U OFDM numerologies for frequencies below 6 GHz.

When operating in unlicensed spectrum, many regions in the world require a device to sense the medium as free before transmitting. This operation may be referred to as listen before talk (LBT). There are many different versions of LBT, depending on which radio technology a device uses and the type of data the device wants to transmit. Common for all versions is that the sensing is done in a particular channel (corresponding to a defined carrier frequency) and over a predefined bandwidth. For example, in the 5 GHz band, the sensing is done over 20 MHz channels.

Many devices are capable of transmitting (and receiving) over a wide bandwidth including of multiple sub-bands/channels, e.g., LBT sub-band (i.e., the frequency part with bandwidth equal to LBT bandwidth). A device is only allowed to transmit on the sub-bands where the medium is sensed as free. Again, there are different versions of how the sensing should be done when multiple sub-bands are involved.

In principle, in some examples, there are two ways a device can operate over multiple sub-bands. One way is that the transmitter/receiver bandwidth is changed depending on which sub-bands were sensed as free. In this setup, there may be only one component carrier (CC) and the multiple sub-bands are treated as single channel with a larger bandwidth. The other way is that the device operates almost independent processing chains for each channel. Depending on how independent the processing chains are, this option can be referred to in some examples as either carrier aggregation (CA) or dual connectivity (DC).

### Channel Access Procedure in NR Unlicensed Spectrum

Listen-before-talk (LBT) is designed at least in part for unlicensed spectrum co-existence with other RATs. In this mechanism, in some examples, a radio device applies a clear channel assessment (CCA) check (i.e. channel sensing) before any transmission. During CCA, the transmitter performs energy detection (ED) over a time period compared to a certain threshold (ED threshold) in order to determine if a channel is idle. In case the channel is determined to be occupied, the transmitter performs a random back-off within a contention window before the next CCA attempt. In order to protect ACK transmissions, the transmitter must defer a period after each busy CCA slot prior to resuming back-off. As soon as the transmitter has gained access to a channel, the transmitter is only allowed to perform transmission up to a maximum time duration (namely, the maximum channel occupancy time (MCOT)). For QoS differentiation, a channel access priority based on the service type has been defined. For example, there are four LBT priority classes defined for differentiation of contention window sizes (CWS) and MCOT between services.

### COT Sharing in NR-U

For a device or node (e.g., NR-U gNB/UE, LTE-LAA eNB/UE, or Wi-Fi AP/STA) to be allowed to transmit in unlicensed spectrum (e.g., 2.4 GHz or 5 GHz band) it typically needs to perform a clear channel assessment (CCA). This procedure typically includes sensing the medium to be idle for a number of time intervals. Sensing the medium to be idle can be done in different ways, e.g. using energy detection, preamble detection or using virtual carrier sensing. The latter may imply that the node (or device) reads control information from other transmitting nodes informing when a transmission ends. After sensing the medium to be idle, the node or device is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

In Wi-Fi, feedback of data reception acknowledgements (ACKs) is transmitted without performing clear channel assessment. Preceding feedback transmission, a small time duration (called Short Interframe Space, SIFS) is introduced between the data transmission and the corresponding feedback which does not include actual sensing of the channel. In 802.11, for example, the SIFS period (e.g. 16 μs for 5 GHz OFDM PHYs) aSIFSTime is defined as:

aSIFSTime=aRxPHYDelay+aMACProcessingDelay+aRxTxTurnaroundTime
aRxPHYDelay defines the duration needed by the PHY layer to deliver a packet to the MAC layer
aMACProcessingDelay defines the duration that the MAC layer needs to trigger the PHY layer transmitting a response
aRxTxTurnaroundTime defines the duration needed to turn the radio from reception into transmit mode

Therefore, the SIFS duration may be used for example to accommodate for hardware delay to switch the direction from reception to transmission.

It is anticipated that for NR in unlicensed bands (NR-U), a similar gap to accommodate for the radio turnaround time will be allowed. For example, this will enable the transmission of PUCCH carrying uplink control information (UCI) feedback as well as PUSCH carrying data and possible UCI within the same transmit opportunity (TXOP) acquired by the initiating gNB without the UE performing clear channel assessment before PUSCH/PUCCH transmission as long as the gap between DL and UL transmission is less than or equal to 16 us. Operation in this manner is typically called “COT sharing.” An example on COT sharing is illustrated in FIG. 1, which shows transmission opportunities (TXOP) both with and without COT sharing where CCA is performed by the initiating node (gNB). For the case of COT sharing the gap between DL and UL transmission is less than 16 us.

### Multi-TTI PUSCH Scheduling

TR38.889 [1] v 16.0.0 refers to scheduling multiple TTIs for PUSCH each using a separate UL grant in the same PDCCH monitoring occasion as beneficial. Scheduling multiple TTIs for PUSCH, i.e., scheduling multiple TBs with different HARQ process IDs over multiple slots, using a single UL grant, is identified as beneficial and should be supported in NR-U.

A previous agreement on multi-TTI scheduling, as agreed in RAN1 meeting #95, implies that NR-U should at least support scheduling of multiple transport blocks (TBs) with different HARQ process IDs in multiple slots using a single uplink (UL) grant. Also, as agreed in RAN1 meeting =96, scheduling a PUSCH transmission over multiple slotspartial slots by a single downlink control information (DCI) should support at least multiple continuous PUSCHs with separate TBs. Each TB should be mapped to at most one slot or one partial slot

According to RAN1 agreements, multi-TTI (multi-transmission time interval) grants for PUSCH have been agreed to be introduced for NR-U. To enable more LBT opportunities for the UE, it may also be beneficial for the multi-TTI grant to support partial slot type grant at the beginning which switches to full slot grant at slot boundaries. A full slot is defined as 14 consecutive OFDM symbols for normal cyclic prefix. A partial slot is defined as a part of a slot, for example a number of consecutive OFDM symbols that do not form a full slot. For example, a partial slot may comprise 1, 2 or 3 consecutive OFDM symbols, or any number of consecutive symbols less than the number of symbols (e.g. 14) in a full slot. An example of how the multi-TTI grant would operate with LBT and with mix of partial slots and full slots is shown in the below FIG. 2, which shows examples of operation with multi-TTI grants. FIG. 2 shows an example of a multi TTI grant 200 containing 6 slots. No information can be transmitted in the first two slots due to CCA failures 9 e.g. channel occupied). Uplink information (U) can be transmitted in the following four slots. FIG. 2 also shows an example of a multi TTI grant 200 containing 4 partial slots (referred to in FIG. 2 as mini-slots) followed by 4 slots. No information can be transmitted in the first two partial slots due to CCA failures. Uplink information (U) can be transmitted in the next two partial slots and the following four full slots.

From FIG. 2, it is observed that:
1) Multi-TTI grant with a mix of partial slots and full slots can give more scheduling opportunities to overcome LBT failures, because e.g. the UE can perform CCA more often and gain access to the channel earlier in some examples.
2) As soon as the UE occupies the channel after successful LBT operation, the UE can perform continuous transmissions without LBT operations.

Please note that multi-TTI grant means in some examples a set of grants for transmissions (e.g. PUSCH transmissions) with full slots, partial slots or mixed full slots and partial slots (if there is no special description).

A multi-TTI grant may in some examples comprise a plurality of time periods, e.g. slots, partial slots and/or TTIs (transmission time intervals), which may in some examples be consecutive or contiguous. The multi-TTI grant may in some examples be granted (e.g. by a base station, eNB, gNB etc) to a wireless communications device (e.g. UE) in a single operation, e.g. a single communication from the base station to the UE.

There currently exist certain challenge(s). For example, in NR-U, with multi-TTI grant, a UE may obtain improved scheduling opportunities for UL transmissions. As shown in FIG. 2, for example, the UE receives a single DCI indicating multiple continuous transmission opportunities with separate TBs. In some cases, multi-TTI scheduling may lose scheduling flexibility.

### SUMMARY

Certain aspects of the present disclosure and their embodiments may provide solutions to these or other challenges. One aspect of the present disclosure provides a method in a wireless communication device. The method comprises receiving an allocation of transmission occasions of a channel on a plurality of time periods, and transmitting an indication that no information will be transmitted on at least one of the plurality of transmission occasions.

Another aspect of the present disclosure provides a method performed by a base station. The method comprises receiving an indication that no information will be transmitted by a first wireless communications device in at least one of a plurality of transmission occasions allocated for transmission of a channel by the first wireless communications device to the base station on a plurality of time periods; andallocating at least one of the plurality of transmission occasions for wireless communications with a second wireless communications device.

A further aspect of the present disclosure provides apparatus in a wireless communications device. The apparatus comprises a processor and a memory. The memory contains instructions executable by the processor such that the apparatus is operable to receive an allocation of transmission occasions of a channel on a plurality of time periods, and transmit an indication that no information will be transmitted on at least one of the plurality of transmission occasions.

A still further aspect of the present disclosure provides apparatus in a base station. The apparatus comprises a processor and a memory. The memory contains instructions executable by the processor such that the apparatus is operable to receive an indication that no information will be transmitted by a first wireless communications device in at least one of a plurality of transmission occasions allocated for transmission of a channel by the first wireless communications device to the base station on a plurality of time periods, and allocate at least one of the plurality of transmission occasions for wireless communications with a second wireless communications device.

An additional aspect of the present disclosure provides apparatus in a wireless communications device. The apparatus is configured to receive an allocation of transmission occasions of a channel on a plurality of time periods, and transmit an indication that no information will be transmitted on at least one of the plurality of transmission occasions.

Another aspect of the present disclosure provides apparatus in a base station. The apparatus is configured to receive an indication that no information will be transmitted by a first wireless communications device in at least one of a plurality of transmission occasions allocated for transmission of a channel by the first wireless communications device to the base station on a plurality of time periods, and allocate at least one of the plurality of transmission occasions for wireless communications with a second wireless communications device.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of transmission opportunities (TXOP) both with and without COT sharing where CCA is performed by the initiating node (gNB);

FIG. 2 shows examples of operation of multi-TTI grants;

FIG. 3 is a flow chart of an example of a method in a wireless communication device;

FIG. 4 is a flow chart of an example of a method performed by a base station;

FIG. 5 shows an example of a wireless network in accordance with some embodiments;

FIG. 6 shows an example of a User Equipment (UE) in accordance with some embodiments;

FIG. 7 is a schematic block diagram illustrating a virtualization environment in accordance with some embodiments;

FIG. 8 shows a telecommunication network connected via an intermediate network to a host computer in accordance with some embodiments;

FIG. 9 shows a host computer communicating via a base station with a user equipment over a partially wireless connection in accordance with some embodiments;

FIG. 10 shows methods implemented in a communication system in accordance with some embodiments;

FIG. 11 shows methods implemented in a communication system in accordance with some embodiments;

FIG. 12 shows methods implemented in a communication system in accordance with some embodiments;

FIG. 13 shows methods implemented in a communication system including a host computer, a base station and a user equipment in accordance with some embodiments; and

FIG. 14 illustrates a schematic block diagram of virtualization apparatus in accordance with some embodiments.

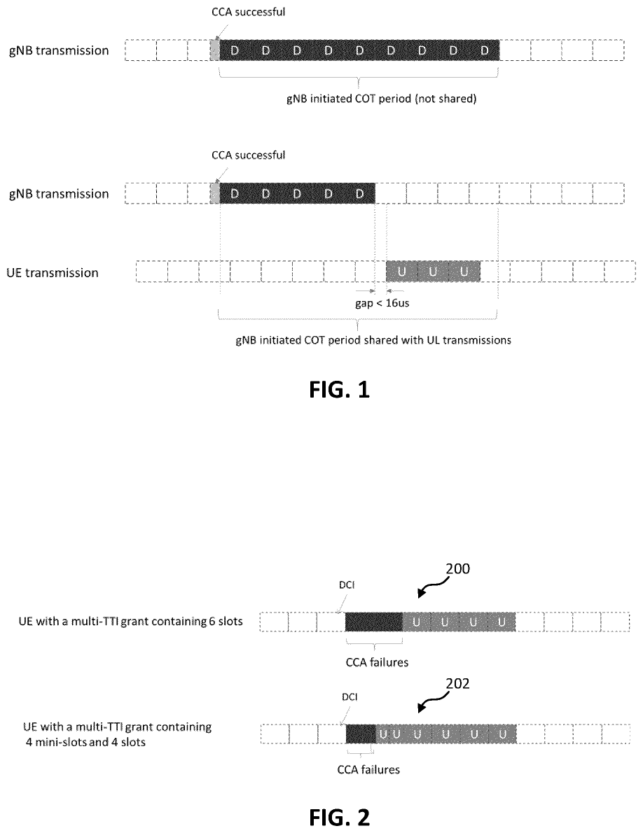

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

As indicated above, in some cases, multi-TTI scheduling may lose scheduling flexibility. The scheduled resources for a UE may then be too much or overbooked, since e.g. there may be mismatch of UE buffer status between a UE and the gNB. It may be not a good idea for the UE to transmit delay insensitive data with multi-TTI scheduling. In this case, it may be beneficial for this UE to stop/skip some TTIs/slots so that the gNB can e.g. reschedule the slots for other UEs, otherwise these overbooked resources may be wasted. The same issue may also be relevant to configured periodic grant resources for a UE. The configured resources may be overbooked for the UE so that the resources may be wasted, if the UE doesn't have sufficient data to fill up the resources.

There are, proposed herein, various embodiments which address one or more of the issues disclosed above. For example, a method in a first wireless communication device is provided. The method comprises transmitting an indication that no information will be transmitted in one or more time periods of a plurality of time periods allocated for a transmission occasion of a channel by the first wireless communication device to a second wireless communication device. In another example, a method performed by a base station is provided. The method comprises receiving an indication that no information will be transmitted by a first wireless communications device in one or more time periods of a plurality of time periods allocated for a transmission occasion of a channel by the first wireless communications device to the base station, and allocating at least one of the one or more time periods for wireless communications with a second wireless communications device.

Certain embodiments may provide one or more of the following technical advantage(s). For example, embodiments disclosed herein may increase scheduling flexibilities and/or efficiencies, to avoid wastage of overbooked resources e.g. via multi-TTI scheduling.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

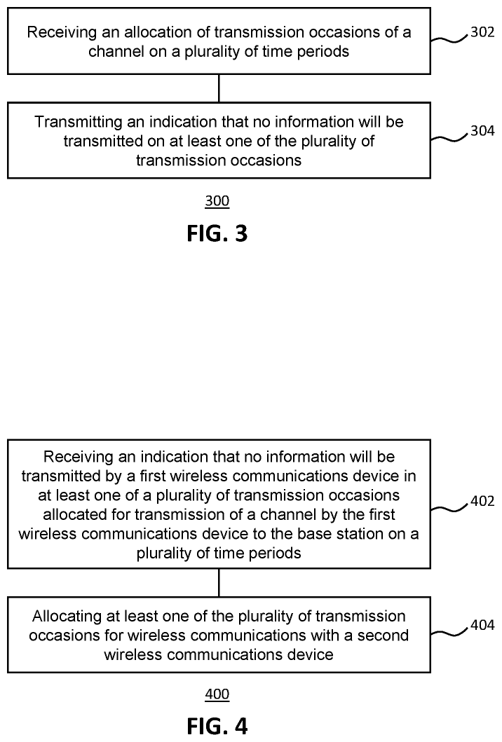

FIG. 3 is a flow chart of an example of a method 300 in a wireless communication device. The method 300 comprises, in step 302, receiving an allocation of transmission occasions of a channel on a plurality of time periods, and in step 304, transmitting an indication that no information will be transmitted on at least one of the plurality of transmission occasions. The transmission occasions may be for example occasions where the wireless communication device is granted or allocated resources, such as the plurality of time periods, and this may be performed in a single allocation or grant.

In some examples, the transmission occasions may be for example a particular transmission of a channel, e.g. PUSCH (physical uplink shared channel). Therefore, for example, the plurality of transmission occasions may be for example a channel (e.g. PUSCH) duration or channel (e.g. PUSCH) transmission duration, e.g. the time duration that the intended PUSCH transmission spans in time, or the number of consecutive OFDM symbols. For transmissions of other channels or data, the plurality of transmission occasions may in some examples be referred to as a transmission duration, that is, for example, the duration of the transmission that the first wireless communication device intends to send, or the length of time (e.g. number of consecutive OFDM symbols) that has been allocated to the first wireless device for the transmission occasion.

In some examples, the at least one of the plurality of transmission occasions on which no information will be transmitted, indicates one or more indices corresponding to the at least one of the plurality of transmission occasions on which no information will be transmitted and/or indicates a number of transmission occasions of the at least one of the plurality of transmission occasions on which no information will be transmitted.

Transmitting the indication in step 304 may in some examples comprise transmitting the indication in a time period of the plurality of time periods earlier than the at least one of the plurality of transmission occasions on which no information will be transmitted. For example, it may comprise transmitting the indication in a time period that is not one of a predetermined at least one one or more earliest in time time periods of the plurality of time periods that are the earliest in time of the at least one time period.

In some examples, transmitting the indication in step 304 comprises transmitting the indication on a channel different to the channel associated with the transmission occasions.

In some examples, transmitting the indication in step 304 may comprise transmitting the indication on a channel, subband, bandwidth Part, BWP, carrier and/or cell different to a channel, subband, bandwidth Part, BWP, carrier and/or cell associated with the transmission occasions.

The method 300 may in some examples comprise transmitting the indication in response to a determination that no information will be transmitted by the first wireless communication device in the at least one time period.

In some examples, the method comprises determining that no information will be transmitted in the at least one of the plurality of transmission occasions based on a buffer status, an amount of information to be transmitted in the transmission occasion, a number of earlier Listen Before Talk (LBT) failures and/or a channel occupancy of the channel associated with the transmission occasion.

The indication may for example indicate whether the at least one of the plurality of transmission occasions may be reused for one or more other wireless communication devices. Additionally or alternatively, the indication may indicate, for example, service priorities associated with the data that are transmitted in the at least one time period.

In some examples, the method 300 may comprise transmitting information in at least one time period earlier than the at least one of the plurality of transmission occasions, and the indication comprises padding information transmitted after the information.

The at least one time period may comprise for example the latest in time at least one time period of the plurality of time periods in some examples.

Each time period may comprise for example a TTI, slot or partial slot. In some examples, a TTI may correspond to the Transport block (TB) length. Each TTI may in some examples use a different HARQ process ID. Maximum TTI length may in some examples be one slot, but may be shorter (e.g. a “partial slot”).

In some examples, multi-TTI may comprise multiple time periods for a physical channel, scheduled with a single grant. In some examples this may be referred to alternatively as multi-slot (which may include slots and/or partial slots).

A partial slot may comprise a time period that is shorter than a slot. Multiple partial slots may be included within a single slot in some examples. The transmissions may have a length of e.g. 7 OFDM symbols or less, e.g. 1,2,3,4,5,6,7 symbols in length. Where a slot has a length of e.g. 14 OFDM symbols, a partial slot may have a length of any number of symbols less than 14. In some examples, a partial slot may comprise half a slot, and may align to slot boundaries, i.e. a slot may contain two partial slots.

In some embodiments, each time period may have the same length or may vary in length. For example, the time periods may include a mix of partial slots and full slots. Therefore, in such examples, some of the time periods are longer (in symbol length) than others: some may be “short” (e.g. less than 14 symbols, such as 7 symbols), and some may occupy the full available length of slot (e.g. 14 symbols in length).

The transmission occasions may in some examples comprise transmission occasions of a PUSCH transmission.

In some examples, the plurality of time periods comprise a plurality of consecutive and/or contiguous time periods.

Transmitting the indication in step 304 of the method 300 may in some examples comprise transmitting the indication in at least one of:
(i) uplink control information, UCI, transmitted on a PUCCH;
(ii) uplink control information, UCI, transmitted on a PUSCH;
(iii) a medium access control control element, MAC CE;
(iv) a radio resource control, RRC, signalling message; and
(v) a random access Msg3 or MsgA message.

The wireless communications device may in some examples be a wireless device or user equipment (UE), and the indication is transmitted to a base station or a network node. The method 300 may thus for example be carried out by the wireless device or user equipment. Alternatively, for example, the wireless communications device comprises a base station, and the indication may be transmitted to a wireless device or user equipment.

FIG. 4 is a flow chart of an example of a method 400 performed by a base station. The method comprises, in step 402, receiving an indication that no information will be transmitted by a first wireless communications device in at least one of a plurality of transmission occasions allocated for transmission of a channel by the first wireless communications device to the base station on a plurality of time periods. Optionally, prior to the receiving of the indication, the base station transmits an allocation to the first wireless communication device for a multiple slot allocation. The method 400 optionally also comprises, in step 404, allocating at least one of the plurality of transmission occasions for wireless communications with a second wireless communications device. In some examples, the second wireless communication device may be different to the first wireless communication device, whereas in other examples they may comprise the same wireless communication device.

In some examples, the method 400 comprises sending an allocation of the transmission occasions of the channel to the first wireless communications device before receiving the indication.

In some examples, the indication identifies the at least one of the plurality of transmission occasions in which no information will be transmitted, indicates one or more indices corresponding to the at least one of the plurality of transmission occasions in which no information will be transmitted and/or indicates a number of the at least one of the plurality of transmission occasions in which no information will be transmitted.

Receiving the indication in step 402 in some examples comprises receiving the indication in a time period of the plurality of time periods earlier than the at least one time period in which no information will be transmitted. For example, this may comprise receiving the indication in a time period that is not one of a predetermined at least one one or more earliest in time time periods of the plurality of time periods that are the earliest in time of the at least one time period.

In some examples, receiving the indication may comprise receiving the indication on a second channel different to the channel associated with the transmission occasion. Receiving the indication may comprise for example receiving the indication on a channel, subband, bandwidth Part, BWP, carrier and/or cell different to a channel, subband, bandwidth Part, BWP, carrier and/or cell associated with the transmission occasion.

In some examples, the method 400 comprises determining that no information will be transmitted in the at least one of the plurality of transmission occasions based on a buffer status report received from a node associated with the transmission occasion.

The indication may comprise for example padding information received from the first wireless communications device after information received in at least one time period earlier than the at least one of the plurality of transmission occasions. The at least one time period may comprise for example the latest in time at least one time period of the plurality of time periods.

In some examples, each of the plurality of time periods comprises a respective one of a transmission time interval (TTI), a time slot, and a partial slot.

Receiving the indication in step 402 may comprise in some examples receiving the indication in at least one of:
(i) uplink control information, UCI, transmitted on a PUCCH;
(ii) uplink control information, UCI, transmitted on a PUSCH;
(iii) a medium access control control element, MAC CE;
(iv) a radio resource control, RRC, signalling message; and p1 (v) a random access Msg3 or MsgA message.

In some examples, the first wireless communications device comprises a wireless device or user equipment, and/or the second wireless communications device comprises a wireless device or user equipment. In some examples, the indication is received from the first wireless communications device

Particular example embodiments will now be described. At least some of these example embodiments may be described referring to particular technologies, e.g. NR, and/or between certain wireless communication devices, e.g. for UL transmissions from a UE to a gNB. However, these examples may be applied using different technologies and/or between different devices where appropriate, including for DL transmissions in some examples. Additionally or alternatively, transmissions may be performed in unlicensed or licensed spectrum. Also, where TTIs, slots and partial slots are referred to, these may alternatively be interpreted of non-limiting examples of time periods (and thus a slot may be interpreted as alternatively being a TTI, a partial slot, or some other time period).

Furthermore, these specific examples refer to multi-TTI grant, though can be applied to the generic case of a plurality of time periods allocated for a transmission occasion of a channel (e.g. PUSCH) by the first wireless communication device to a second wireless communication device. Where a multi-TTI grant is indicated, this may be interpreted alternatively as being a transmission occasion grant, e.g. grant or allocation of the plurality of time periods for the transmission occasion of the channel.

The below embodiments are described in the context of NR unlicensed operation (NR-U). However, embodiments are not limited to NR-U scenarios. Examples disclosed herein may also be applicable to other unlicensed operation scenarios such as LTE LAA/eLAA/feLAA. They may also be applicable to licensed operation scenarios, e.g. where multi-TTI scheduling is used for other intentions, such as latency reduction for example. Please note that multi-TTI grant in some examples means a set of grants which can be configured via multi-TTI/slot scheduling scheme or configured scheduling scheme. Embodiments disclosed herein may also be applicable for the example case where a set of subsequent grants in time domain are allocated via multiple separate DCIs. One or more features of the examples disclosed herein may be used in other examples disclosed herein where appropriate (e.g. where technically compatible).

In an example embodiment, while a UE receives a multi-TTI grant (e.g. for a transmission occasion of a channel such as PUSCH), the UE estimates whether there is sufficient data in the UE buffer to fully utilize all the slots/TTIs associated with the grant. For unlicensed band, the UE may in some examples make estimation considering measured channel occupancy or LBT failure statistics. If the estimation indicates that there may be some free slots/TTIs left unused (e.g. not containing any data or information other than e.g. padding information), the UE can include an indication (e.g. one or more indicators) in transmissions to the gNB so that those free slots can be rescheduled (e.g. by the gNB) for other transmissions, i.e., early termination of the multi-TTI grant or transmission occasion for the UE. Upon reception of the indication, the gNB may in some examples decide to reschedule overbooked resources to other transmissions, e.g. via another DCI.

In another example, the indication may explicitly or implicitly indicate at least one of the following information, such as:
1) Whether or not there are free slots
2) Slot indices of free slots within this scheduled multi-TTI period
3) Indicator on whether free slots are allowed to be shared with other UEs—if not, this may mean for example that the free slots may be only rescheduled for DL transmissions for this UE.
4) Service priority indicators of the data that are transmitted within this scheduled multi-TTI period
5) A number of free slots (or alternatively the number of utilized slots). This may be used in some examples by the gNB to determine which slots are free, where the utilized slots are predetermined, e.g. where the utilized slots are the earliest in time slots in the transmission occasion.

As another example embodiment, the indication may be signaled by the wireless device to the radio access network (e.g. gNB) via at least one of the following signaling means, such as:
1) Included in the UCI, and transmitted on PUCCH
2) Included in the UCI, and transmitted on PUSCH
3) Carried by a new MAC CE.
4) Carried by an RRC signaling message.
5) Included in a RA message, for example, in Msg3 in 4-step RA, or in MsgA in 2-step RA.

The signaling may in some examples be carried on another LBT subband/LBT channel/BWP/carrier/cell (e.g. different to that being used to transmit on the transmission occasion).

As another example embodiment, the free slot availability can be implicitly indicated using a BSR in a transmitted MAC PDU. This BSR MAC CE can be set with higher priority than data for radio resource allocation during MAC PDU construction. To ensure the gNB has sufficient time to perform scheduling to reuse the free slots, for example, this BSR MAC CE can be provided one or more slots earlier than the last PUSCH transmission according to the multi-TTI grant (this may also apply in other examples where a generic indication is provided one or more slots or time periods before the end of the transmission occasion). The gNB may determine how many UL grants of the multi-TTI grant will be used by the UE to empty its transmit buffer and how many slots can be reused based on the received BSR.

As another example embodiment, in order to improve the transmission reliability for an indication (e.g. indicators), the indication may be transmitted in a preconfigured slot or a slot determined by the UE according to a predefined rule in order to avoid that the indicator is failed to transmit due to LBT fails in the start slots/partial slots of the transmission (e.g. multi-TTI period). For instance, the indication may be transmitted in a slot not located at the start of the multi-TTI period (e.g. transmission occasion), still allowing there is sufficient time left for the gNB to receive the signaling, and perform rescheduling for the free slots.

As another example embodiment, early termination of multi-TTI scheduling may be configured/enabled per service/LCH/channel access category/channel access priority class. In one example, it is only applicable to services with critical latency requirements. In this case, while receiving a multi-TTI grant, the UE estimates whether there is sufficient data of services/LCHs/channel access categories/channel access priority classes configured/enabled to use multi-TTI scheduling in the UE buffer.

As another example embodiment, a new UE capability indicator may be defined for the UE to signal support of early termination of the transmission occasion (e.g. multi-TTI grant).

As another example embodiment, when the indicator of early termination of the transmission occasion is transmitted by a UE, the UE is not allowed to perform uplink transmission using the UL grants that can be determined as free slots according to the indicators even if subsequently the UE generates/receives new data or information that can be included in the transmission occasion.

As another example embodiment, the indication can be repeated in multiple PUSCH transmissions, or multiple indications carrying similar information but carried by different channels, can be adopted to enhance robustness of the transmission of the indicator.

As another example embodiment, the UE's buffer may be emptied with the first few transmissions according to the multi-TTI grant. In this case, the indication may comprise padding information, padding data etc that is transmitted by the UE after other information (e.g. data) is transmitted. The gNB may determine the free slots, e.g. according to padding BSR and/or padding bits in the received MAC PDU. For example, the gNB may determine that all time periods in the transmission occasion following the time period containing the padding are free (e.g. no information will be transmitted by the UE in these time periods).

As another example embodiment, the UE can transmit an indication to the gNB to reconfigure its configured grant or reschedule overbooked configured resources to other UEs.

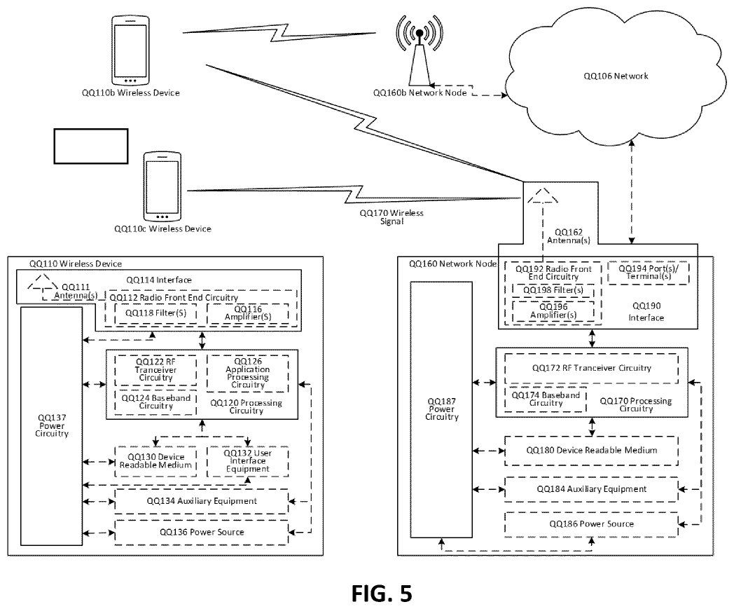

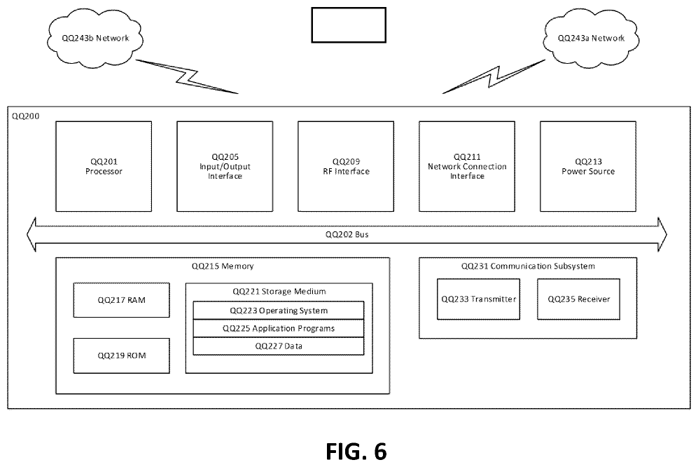

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network QQ106, network nodes QQ160 and QQ160b, and WDs QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 5 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3^{rd} Generation Partnership Project (3GPP), including a NB-IoT UE, a machine type communication (MTC) UE, and/or an enhanced MTC (eMTC) UE. UE QQ200, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 6, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

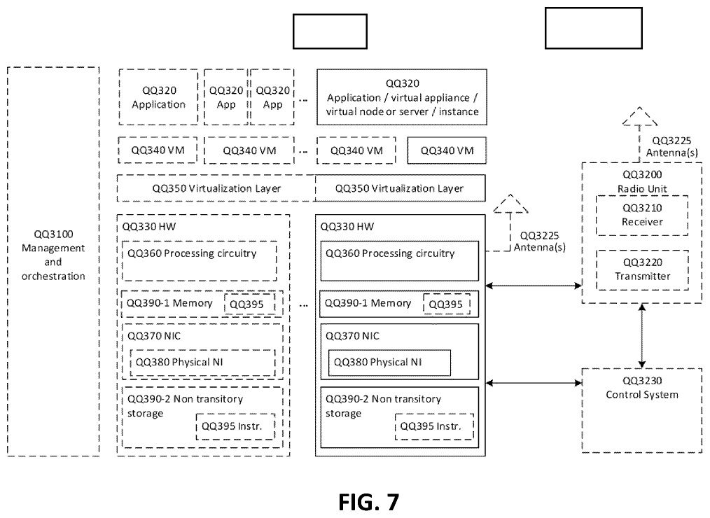

FIG. 7 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 7, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 7.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

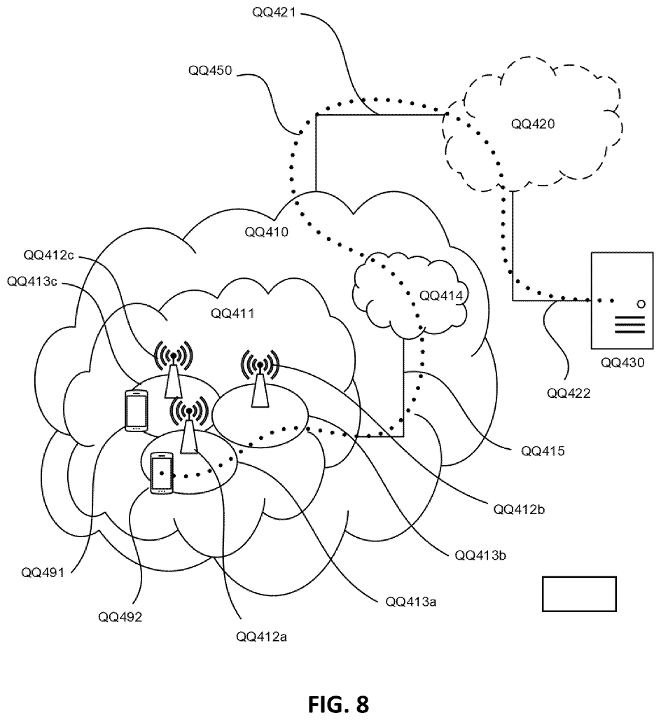

With reference to FIG. 8, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 8 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

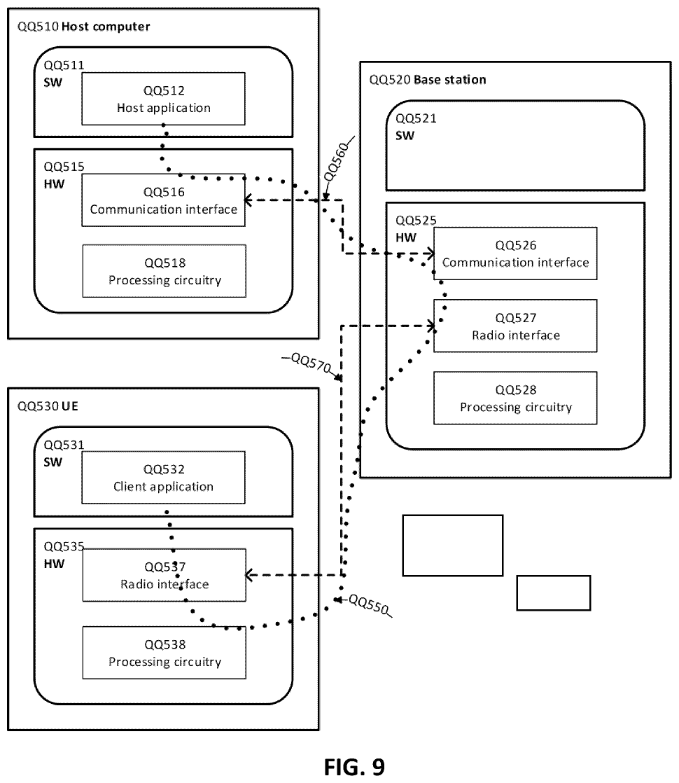

Example implementations, in accordance with an embodiment, of the UE, base station and host computer discussed in the preceding paragraphs will now be described with reference to FIG. 9. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 9) served by base station QQ520. Communication interface QQ526 may be configured to facilitate connection QQ560 to host computer QQ510. Connection QQ560 may be direct or it may pass through a core network (not shown in FIG. 9) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 9 may be similar or identical to host computer QQ430, one of base stations QQ412a, QQ412b, QQ412c and one of UEs QQ491, QQ492 of FIG. 8, respectively. This is to say, the inner workings of these entities may be as shown in FIG. 9 and independently, the surrounding network topology may be that of FIG. 8.

In FIG. 9, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may improve the signaling efficiency and thereby provide benefits such as improved battery life, improved network efficiency etc.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

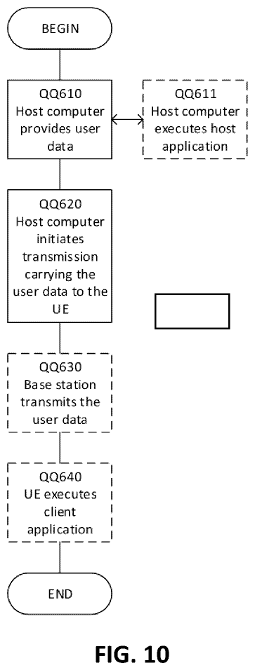

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

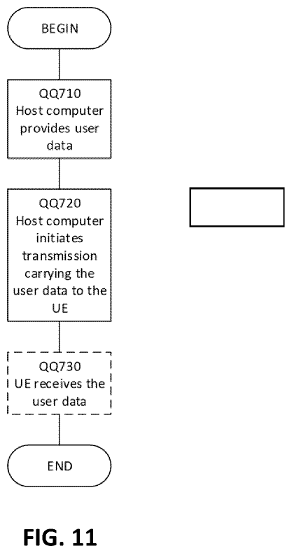

FIG. 11 is a flowchart illustrating a method implemented in a communication system, in accordance with one embodiment. The communication system includes a host computer, a base station and a UE which may be those described with reference to FIGS. 8 and 9

For simplicity of the present disclosure, only drawing references to FIG. 11 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

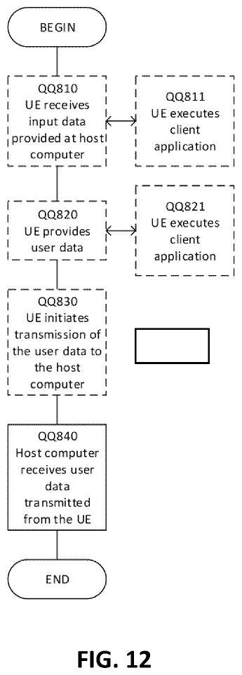

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

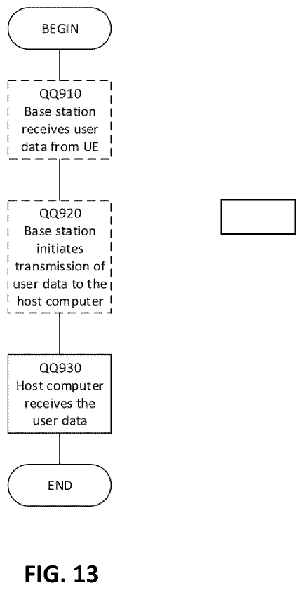

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

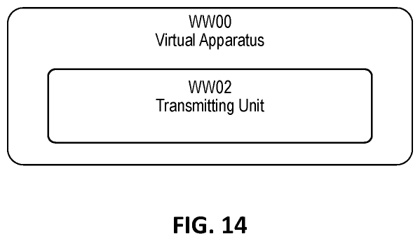

FIG. 14 illustrates a schematic block diagram of an apparatus WW00 in a wireless network (for example, the wireless network shown in FIG. 5). The apparatus may be implemented in a wireless device or network node (e.g., wireless device QQ110 or network node QQ160 shown in FIG. 5). Apparatus WW00 is operable to carry out the example method described with reference to FIG. 3 and possibly any other processes or methods disclosed herein. It is also to be understood that the method of FIG. 3 is not necessarily carried out solely by apparatus WW00. At least some operations of the method can be performed by one or more other entities.

Virtual Apparatus WW00 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first scheduling unit WW02, second scheduling unit WW04 and/or any other suitable units of apparatus WW00 to perform corresponding functions according one or more embodiments of the present disclosure.

Virtual apparatus WW00 may be configured with a list of at least one configuration, each of the at least one configuration associated with a respective conditional mobility procedure and a respective potential target cell.

As illustrated in FIG. 14, apparatus WW00 includes transmitting unit WW02 that is configured to transmit an indication that no information will be transmitted in one or more time periods of a plurality of time periods allocated for a transmission occasion of a channel by the first wireless communication device to a second wireless communication device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The following enumerated embodiments form part of the present disclosure:

### Group A Embodiments

1. A method in a first wireless communication device, the method comprising:
transmitting an indication that no information will be transmitted in one or more time periods of a plurality of time periods allocated for a transmission occasion of a channel by the first wireless communication device to a second wireless communication device.

2. The method of embodiment 1, wherein the indication identifies the one or more time periods.

3. The method of embodiment 1 or 2, wherein transmitting indication comprises transmitting the indication in a time period of the plurality of time periods earlier than the one or more time periods.

4. The method of embodiment 3, comprising transmitting the indication in a time period that is not one of a predetermined one or more earliest in time time periods of the plurality of time periods.

5. The method of embodiment 1 or 2, wherein transmitting the indication comprises transmitting the indication on a second channel different to the channel associated with the transmission occasion.

6. The method of any of the preceding embodiments, comprising transmitting the indication in response to a determination that no information will be transmitted by the first wireless communication device to a second wireless communication device in the one or more time periods.

7. The method of any of the preceding embodiments, comprising determining that no information will be transmitted in the one or more time periods.

8. The method of embodiment 7, comprising determining that no information will be transmitted in the one or more time periods based on a buffer status, an amount of information to be transmitted in the transmission occasion, a number of earlier Listen Before Talk (LBT) failures and/or a channel occupancy of the channel associated with the transmission occasion.

9. The method of any of the preceding embodiments, wherein the indication indicates one or more indices corresponding to the one or more time periods.

10. The method of any of the preceding embodiments, wherein the indication indicates a number of the one or more time periods.

11. The method of any of the preceding embodiments, wherein the indication indicates whether the one or more time periods may be reused for wireless communications between the second wireless communication device and one or more other wireless communication devices.

12. The method of any of the preceding embodiments, wherein the indication indicates service priorities associated with the data that are transmitted in the one or more time periods

13. The method of any of the preceding embodiments, comprising transmitting information in at least one time period earlier than the one or more time periods.

14. The method of embodiment 13, wherein the indication comprises padding information transmitted after the information.

15. The method of any of the preceding embodiments, wherein the one or more time periods comprise the latest in time one or more time periods of the plurality of time periods.

16. The method of any of the preceding embodiments, wherein each of the plurality of time periods comprises a respective one of a transmission time interval (TTI), a time slot, and a mini-slot.

17. The method of any of the preceding embodiments, wherein each of the plurality of time periods comprises a respective number of OFDM symbol durations.

18. The method of any of the preceding embodiments, wherein the transmission occasion comprises a PUSCH transmission occasion.

19. The method of any of the preceding embodiments, wherein the plurality of time periods comprise a plurality of consecutive and/or contiguous time periods.

20. The method of any of the preceding embodiments, wherein the first wireless communications device comprises a wireless device or user equipment.

21. The method of embodiment 20, wherein the method is carried out by the wireless device or user equipment.

22. The method of any of the preceding embodiments, wherein the indication is transmitted to a base station.

23. The method of any of embodiments 1 to 19, wherein the first wireless communications device comprises a base station.

24. The method of embodiment 23, wherein the indication is transmitted to a wireless device or user equipment.

25. The method of any of the preceding embodiments, further comprising:
providing user data; and
forwarding the user data to a host computer via the transmission to the base station.

### Group B Embodiments

26. A method performed by a base station, the method comprising:
receiving an indication that no information will be transmitted by a first wireless communications device in one or more time periods of a plurality of time periods allocated for a transmission occasion of a channel by the first wireless communications device to the base station; and
allocating at least one of the one or more time periods for wireless communications with a second wireless communications device.

27. The method of embodiment 26, wherein the indication identifies the one or more time periods.

28. The method of embodiment 26 or 27, wherein receiving the indication comprises receiving the indication in a time period of the plurality of time periods earlier than the one or more time periods.

29. The method of embodiment 28, comprising receiving the indication in a time period that is not one of a predetermined one or more earliest in time time periods of the plurality of time periods.

30. The method of embodiment 26 or 27, wherein receiving the indication comprises receiving the indication on a second channel different to the channel associated with the transmission occasion.

31. The method of any of embodiments 26 to 30, comprising determining that no information will be transmitted in the one or more time periods based on a buffer status report received from a node associated with the transmission occasion.

32. The method of any of embodiments 26 to 31, wherein the indication indicates one or more indices corresponding to the one or more time periods.

33. The method of any of embodiments 26 to 32, wherein the indication indicates a number of the one or more time periods.

34. The method of any of embodiments 26 to 33, wherein the indication comprises padding information received from the first wireless communications device after information received in at least one time period earlier than the one or more time periods.

35. The method of any of embodiments 26 to 34, wherein the one or more time periods comprise the latest in time one or more time periods of the plurality of time periods.

36. The method of any of embodiments 26 to 35, wherein each of the plurality of time periods comprises a respective one of a transmission time interval (TTI), a time slot, and a mini-slot.

37. The method of any of embodiments 26 to 36, wherein each of the plurality of time periods comprises a respective number of OFDM symbol durations.

38. The method of any of embodiments 26 to 37, wherein the transmission occasion comprises a PUSCH transmission occasion.

39. The method of any of embodiments 26 to 38, wherein the plurality of time periods comprise a plurality of consecutive and/or contiguous time periods.

40. The method of any of embodiments 26 to 39, wherein the first wireless communications device comprises a wireless device or user equipment.

41. The method of any of embodiments 26 to 40, wherein the second wireless communications device comprises a wireless device or user equipment.

42. The method of any of embodiments 26 to 41, wherein the indication is received from the first wireless communications device.

43. The method of any of embodiments 26 to 42, further comprising:
obtaining user data; and
forwarding the user data to a host computer or a wireless device.

### Group C Embodiments

44. A wireless device, the wireless device comprising:
processing circuitry configured to perform any of the steps of any of the Group A embodiments; and
power supply circuitry configured to supply power to the wireless device.

45. A base station, the base station comprising:
processing circuitry configured to perform any of the steps of any of the Group B embodiments;
power supply circuitry configured to supply power to the base station.

46. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

47. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

48. The communication system of the previous embodiment further including the base station.

49. The communication system of the previous 2 embodiments, further including the UE, wherein the UE is configured to communicate with the base station.

50. The communication system of the previous 3 embodiments, wherein:
the processing circuitry of the host computer is configured to execute a host application, thereby providing the user data; and
the UE comprises processing circuitry configured to execute a client application associated with the host application.

51. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

52. The method of the previous embodiment, further comprising, at the base station, transmitting the user data.

53. The method of the previous 2 embodiments, wherein the user data is provided at the host computer by executing a host application, the method further comprising, at the UE, executing a client application associated with the host application.

54. A user equipment (UE) configured to communicate with a base station, the UE comprising a radio interface and processing circuitry configured to performs the of the previous 3 embodiments.

55. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

56. The communication system of the previous embodiment, wherein the cellular network further includes a base station configured to communicate with the UE.

57. The communication system of the previous 2 embodiments, wherein:
the processing circuitry of the host computer is configured to execute a host application, thereby providing the user data; and
the UE's processing circuitry is configured to execute a client application associated with the host application.

58. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

59. The method of the previous embodiment, further comprising at the UE, receiving the user data from the base station.

60. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

61. The communication system of the previous embodiment, further including the UE.

62. The communication system of the previous 2 embodiments, further including the base station, wherein the base station comprises a radio interface configured to communicate with the UE and a communication interface configured to forward to the host computer the user data carried by a transmission from the UE to the base station.

63. The communication system of the previous 3 embodiments, wherein:
the processing circuitry of the host computer is configured to execute a host application; and
the UE's processing circuitry is configured to execute a client application associated with the host application, thereby providing the user data.

64. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

65. A method implemented in a communication system including a host computer, a base station and a user equipment (UE), the method comprising:
at the host computer, receiving user data transmitted to the base station from the UE, wherein the UE performs any of the steps of any of the Group A embodiments.

66. The method of the previous embodiment, further comprising, at the UE, providing the user data to the base station.

67. The method of the previous 2 embodiments, further comprising:
at the UE, executing a client application, thereby providing the user data to be transmitted; and
at the host computer, executing a host application associated with the client application.

68. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

69. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

70. The communication system of the previous embodiment further including the base station.

71. The communication system of the previous 2 embodiments, further including the UE, wherein the UE is configured to communicate with the base station.

72. The communication system of the previous 3 embodiments, wherein:
the processing circuitry of the host computer is configured to execute a host application;
the UE is configured to execute a client application associated with the host application, thereby providing the user data to be received by the host computer.

73. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

74. The method of the previous embodiment, further comprising at the base station, receiving the user data from the UE.

75. The method of the previous 2 embodiments, further comprising at the base station, initiating a transmission of the received user data to the host computer.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

### 1x RTT CDMA2000 1x Radio Transmission Technology

### AM Acknowledged Mode

### CHO Conditional Handover

### DCCH Dedicated Control Channel

### E-UTRA Evolved Universal Terrestrial Radio Access Network

### HO Handover

### IE Information Element

### LTE Long Term Evolution

### MAC Medium Access Control

### NR New Radio

### PCI Physical Cell Identity

### RAT Radio Access Technology

### RB Radio Bearer

### RLC Radio Link Control

### RRC Radio Resource Control

### SAP Service Access Point

### SRB Signaling Radio Bearer

### TS Technical Specification

UE User Equipment (used interchangeably with wireless device)

### 3GPP 3rd Generation Partnership Project

### 5G 5th Generation

### ABS Almost Blank Subframe

### ARQ Automatic Repeat Request

### AWGN Additive White Gaussian Noise

### BCCH Broadcast Control Channel

### BCH Broadcast Channel

### CA Carrier Aggregation

### CC Carrier Component

### CCCH SDU Common Control Channel SDU

### CDMA Code Division Multiplexing Access

### CGI Cell Global Identifier

### CIR Channel Impulse Response

### CP Cyclic Prefix

### CPICH Common Pilot Channel

CPICH Ec/No CPICH Received energy per chip divided by the power density in the band
CQI Channel Quality information

### C-RNTI Cell RNTI

### CSI Channel State Information

### DCCH Dedicated Control Channel

### DL Downlink

### DM Demodulation

### DMRS Demodulation Reference Signal

### DRX Discontinuous Reception

### DTX Discontinuous Transmission

### DTCH Dedicated Traffic Channel

### DUT Device Under Test

E-CID Enhanced Cell-ID (positioning method)

### E-SMLC Evolved-Serving Mobile Location Centre

### ECGI Evolved CGI

### eNB E-UTRAN NodeB

ePDCCH enhanced Physical Downlink Control Channel
E-SMLC evolved Serving Mobile Location Center

### E-UTRA Evolved UTRA

### E-UTRAN Evolved UTRAN

### FDD Frequency Division Duplex

### FFS For Further Study

### GERAN GSM EDGE Radio Access Network

gNB Base station in NR

### GNSS Global Navigation Satellite System

GSM Global System for Mobile communication

### HARQ Hybrid Automatic Repeat Request

### HO Handover

### HSPA High Speed Packet Access

### HRPD High Rate Packet Data

### LOS Line of Sight

### LPP LTE Positioning Protocol

### LTE Long-Term Evolution

### MAC Medium Access Control

### MBMS Multimedia Broadcast Multicast Services

MBSFN Multimedia Broadcast multicast service Single Frequency Network

### MBSFN ABS MBSFN Almost Blank Subframe

### MDT Minimization of Drive Tests

### MIB Master Information Block

### MME Mobility Management Entity

### MSC Mobile Switching Center

### NPDCCH Narrowband Physical Downlink Control Channel

### NR New Radio

### OCNG OFDMA Channel Noise Generator

### OFDM Orthogonal Frequency Division Multiplexing

### OFDMA Orthogonal Frequency Division Multiple Access

### OSS Operations Support System

### OTDOA Observed Time Difference of Arrival

### O&M Operation and Maintenance

### PBCH Physical Broadcast Channel

### P-CCPCH Primary Common Control Physical Channel

### PCell Primary Cell

### PCFICH Physical Control Format Indicator Channel

### PDCCH Physical Downlink Control Channel

### PDP Profile Delay Profile

### PDSCH Physical Downlink Shared Channel

### PGW Packet Gateway

### PHICH Physical Hybrid-ARQ Indicator Channel

### PLMN Public Land Mobile Network

### PMI Precoder Matrix Indicator

### PRACH Physical Random Access Channel

### PRS Positioning Reference Signal

### PSS Primary Synchronization Signal

### PUCCH Physical Uplink Control Channel

### PUSCH Physical Uplink Shared Channel

### RACH Random Access Channel

### QAM Quadrature Amplitude Modulation

### RAN Radio Access Network

### RAT Radio Access Technology

### RLM Radio Link Management

### RNC Radio Network Controller

### RNTI Radio Network Temporary Identifier

### RRC Radio Resource Control

### RRM Radio Resource Management

### RS Reference Signal

### RSCP Received Signal Code Power

### RSRP Reference Symbol Received Power OR Reference Signal Received Power

### RSRQ Reference Signal Received Quality OR Reference Symbol Received Quality

### RSSI Received Signal Strength Indicator

### RSTD Reference Signal Time Difference

### SCH Synchronization Channel

### SCell Secondary Cell

### SDU Service Data Unit

### SFN System Frame Number

### SGW Serving Gateway

### SI System Information

### SIB System Information Block

### SNR Signal to Noise Ratio

### SON Self Optimized Network

### SS Synchronization Signal

### SSS Secondary Synchronization Signal

### TDD Time Division Duplex

### TDOA Time Difference of Arrival

### TOA Time of Arrival

### TSS Tertiary Synchronization Signal

### TTI Transmission Time Interval

### UE User Equipment

### UL Uplink

### UMTS Universal Mobile Telecommunication System

### USIM Universal Subscriber Identity Module

### UTDOA Uplink Time Difference of Arrival

### UTRA Universal Terrestrial Radio Access

### UTRAN Universal Terrestrial Radio Access Network

### WCDMA Wide CDMA

### WLAN Wide Local Area Network

1. A method in a wireless communication device, the method comprising:
receiving an allocation of transmission occasions of a channel on a plurality of time periods; and
transmitting an indication that no information will be transmitted on at least one of the plurality of transmission occasions.

2. The method of claim 1, wherein
the indication identifies the at least one of the plurality of transmission occasions on which no information will be transmitted,
indicates one or more indices corresponding to the at least one of the plurality of transmission occasions on which no information will be transmitted, and/or
indicates a number of transmission occasions of the at least one of the plurality of transmission occasions on which no information will be transmitted.

3-4. (canceled)

5. The method of claim 1, wherein transmitting the indication comprises transmitting the indication on a channel different to the channel associated with the transmission occasions.

6-7. (canceled)

8. The method of claim 1, comprising determining that no information will be transmitted in the at least one of the plurality of transmission occasions based on a buffer status, an amount of information to be transmitted in the transmission occasion, a number of earlier Listen Before Talk (LBT) failures and/or a channel occupancy of the channel associated with the transmission occasions.

9. The method of claim 1, wherein the indication indicates whether the at least one of the plurality of transmission occasions may be reused for one or more other wireless communication devices.

10-13. (canceled)

14. The method of claim 1, wherein the transmission occasions comprise transmission occasions of a PUSCH transmission.

15. (canceled)

16. The method of claim 1, wherein transmitting the indication comprises transmitting the indication in at least one of:
(i) uplink control information transmitted on a Physical Uplink Control Channel;
(ii) uplink control information transmitted on a Physical Uplink Shared Channel;
(iii) a medium access control control element;
(iv) a radio resource control message; and
(v) a random access message.

17-19. (canceled)

20. A method performed by a base station, the method comprising:
receiving an indication that no information will be transmitted by a first wireless communications device in at least one of a plurality of transmission occasions allocated for transmission of a channel by the first wireless communications device to the base station on a plurality of time periods.

21. The method of claim 20 further comprising allocating at least one of the plurality of transmission occasions for wireless communications with a second wireless communications device.

22. The method of claim 20, comprising sending an allocation of the transmission occasions of the channel to the first wireless communications device before receiving the indication.

23. The method of claim 20, wherein the indication identifies the at least one of the plurality of transmission occasions in which no information will be transmitted, indicates one or more indices corresponding to the at least one of the plurality of transmission occasions in which no information will be transmitted and/or indicates a number of the at least one of the plurality of transmission occasions in which no information will be transmitted.

24-27. (canceled)

28. The method of claim 20, comprising determining that no information will be transmitted in the at least one of the plurality of transmission occasions based on a buffer status report received from a node associated with the transmission occasions.

29. The method of claim 20, wherein the indication comprises padding information received from the first wireless communications device after information received in at least one time period earlier than the at least one of the plurality of transmission occasions.

30-33. (canceled)

34. The method of claim 20, wherein receiving the indication comprises receiving the indication in at least one of:
(i) uplink control information transmitted on a Physical Uplink Control Channel;
(ii) uplink control information transmitted on a Physical Uplink Shared Channel;
(iii) a medium access control control element;
(iv) a radio resource control message; and
(v) a random access message.

35-39. (canceled)

40. A wireless communications device (WCD), the WCD comprising a processor and a memory, the memory containing instructions executable by the processor such that the WCD is configured to:
receive an allocation of transmission occasions of a channel on a plurality of time periods; and
transmit an indication that no information will be transmitted on at least one of the plurality of transmission occasions.

41. The WCD of claim 40, wherein the memory contains instructions executable by the processor such that the WCD is operable to transmit the indication by transmitting the indication in a time period of the plurality of time periods earlier than the at least one of the plurality of transmission occasions on which no information will be transmitted.

42. The WCD of claim 40, wherein the memory contains instructions executable by the processor such that the WCD is operable to transmit the indication by transmitting the indication on a channel different to the channel associated with the transmission occasions.

43. (canceled)

44. The WCD of claim 40, wherein the memory contains instructions executable by the processor such that the WCD is operable to determine
that no information will be transmitted in the at least one of the plurality of transmission occasions based on a buffer status,
an amount of information to be transmitted in the transmission occasion,
a number of earlier Listen Before Talk (LBT) failures, and/or
a channel occupancy of the channel associated with the transmission occasion.

45. (canceled)

46. A base station (BS), the BS comprising a processor and a memory, the memory containing instructions executable by the processor such that the BS is operable to:
receive an indication that no information will be transmitted by a first wireless communications device in at least one of a plurality of transmission occasions allocated for transmission of a channel by the first wireless communications device to the base station on a plurality of time periods.

47. The BS of claim 46 further comprising allocating at least one of the plurality of transmission occasions for wireless communications with a second wireless communications device.

48. The BS of claim 46, wherein receiving the indication comprises receiving the indication in a time period of the plurality of time periods earlier than the at least one of the plurality of transmission occasions on which no information will be transmitted.

49. (canceled)

50. The BS of claim 46, comprising determining that no information will be transmitted in the at least one of the plurality of transmission occasions based on a buffer status report received from a node associated with the transmission occasions.

51-54. (canceled)
